(19) United States
(12) Patent Application Publication
(10) Pub. No.: US 2025/0304239 A1
(43) Pub. Date: Oct. 2, 2025

(54) ROTARY BLADE

(71) Applicant: Ratier-Figeac SAS, Figeac (FR)

(72) Inventor: Bruno SEMINEL, Figeac (FR)

(21) Appl. No.: 19/059,479

(22) Filed: Feb. 21, 2025

(30) Foreign Application Priority Data
Mar. 28, 2024 (EP) 24305467.3

(51) Int. Cl. F01D 5/28

(52) U.S. Cl. CPC F01D 5/282; F05D 2230/23; F05D 2300/603

(57) ABSTRACT

A rotary blade includes one or more structural beams extending generally in a direction from a root end of the blade to a tip of the blade, a shell enclosing the one or more structural beams and defining the outer shape of the blade, wherein the one or more structural beams is made of a thermoplastic material and the shell is formed of a fibrous material. The blade includes a thermoset resin injected into the shell fibrous material to strengthen the shell and to bond the shell to the one or more beams.

### CROSS-REFERENCE TO RELATED APPLICATIONS

This application claims the benefit of European Patent Application No. 24305467.3 filed Mar. 28, 2024, the disclosure of which is incorporated herein by reference in its entirety.

### FIELD

The present disclosure relates to a rotary blade for a flying vehicle and a method of making such a blade.

### BACKGROUND

Many aircraft or flying vehicles such as airplanes, helicopters, unmanned aerial vehicles, vertical-take-off-and landing vehicles, drones etc. use composite blades, often in a propeller, rotor or fan. Such blades are highly loaded structural components as the propeller, rotor fan rotates during operation of the aircraft. These blades need to resist: centrifugal loads, aerodynamic loads, and impacts due to flying objects such as birds, stones etc.

Composite blades include fibre-reinforced composite (FRC) materials, and may include other materials such as a foam core and/or a metal root for connecting the blade to a hub. FRC materials include (high-strength) fibres embedded in a matrix. Composite blades are often preferred over metal blades, as FRC blades can provide lighter weight blades while maintaining sufficient strength and stiffness for use in a propeller or fan. In composite blades, it is typical to use epoxy (i.e. a thermoset polymer) for the matrix. Weight to strength ratio of such blades has been improved by the use of carbon spars or beams encased in a thermoset resin. A number of thermoset polymers are sufficiently strong and creep-resistant to work as composite blades. A disadvantage of thermoset composites is that, once set, the shape is fixed. If there is a manufacturing defect, a whole blade may need to be scrapped and cannot be recycled due to the irreversible nature of the thermosetting process. Furthermore, making blades using such thermoset resins requires a long cure time and a relatively expensive and time intensive procedure that needs to be precisely controlled. Often, the impact strength of such materials may be a limiting factor for the potential conditions aircraft may face.

There is a desire for stronger, but still light blade structures that can be more easily, quickly and efficiently manufactured.

### SUMMARY

According to a first aspect, there is provided a rotary blade for a flying vehicle, the blade comprising one or more structural beams extending generally in a direction from a root end of the blade to a tip of the blade, a shell enclosing the one or more structural beams and defining the outer shape of the blade, and a filler material within the shell and encasing the one or more structural beams, wherein the one or more structural beams is made of a thermoplastic material with reinforcement fibers and the shell comprises a fibrous material, the blade further comprising a thermoset resin injected and set around fibers of the shell fibrous material and around the one or more beams.

The reinforcement fibers may be e.g. carbon fibers, glass, aramide or any known fibers for FRC.

According to another aspect, there is provided a method of forming an aircraft blade, the method comprising: forming one or more structural beams of the blade made of a thermoplastic material; combining the one or more beams, with a core of filler material to produce an assembly; applying a fibre shell over the assembly; and performing Resin Transfer Molding, RTM, on the assembly in the fiber shell, wherein the RTM includes injecting a thermoset resin into the shell and the assembly and solidifying the resin, to produce the finished aircraft blade.

### BRIEF DESCRIPTION OF DRAWINGS

Certain embodiments of the present disclosure will now be described in greater detail by way of example only and with reference to the accompanying drawings in which:

FIG. 1 shows a cross section of an aircraft blade having a known structure;

FIG. 2 shows a perspective view of two parts of a blade according to this disclosure;

FIG. 3 shows a cross section of further parts of a blade according to the disclosure; and

FIG. 4 shows a flowchart depicting a method of making a blade according to the disclosure.

### DETAILED DESCRIPTION

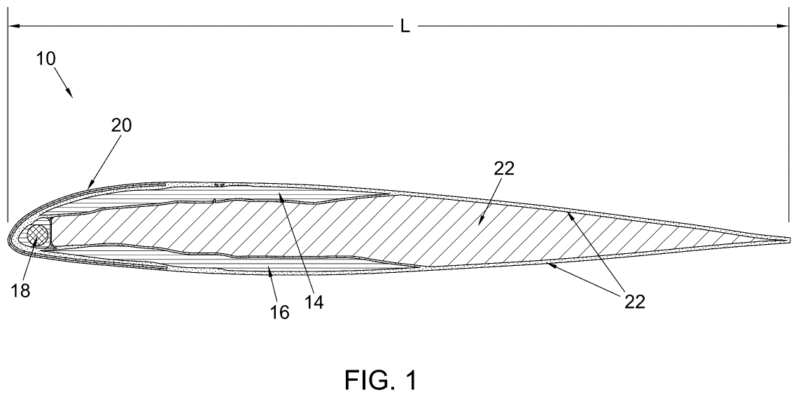

FIG. 1 shows, by way of background, a cross-section of a blade 10 for an aircraft. By way of example only, the blade 10 may be suitable for use in a fan of a gas turbine engine or in a propeller or a helicopter rotor.

The blade 10 comprises a fibre shell 12 that encloses first 14 and second 16 beams. The first beam 14 is located adjacent the suction-side of the blade 10, immediately inward from the fibre shell 12. The second beam 16 is located on the pressure-side of the blade 10, immediately inward from the fibre shell 12.

A leading edge sheath 20 may be located on an outward side of the fibre shell 12, spanning from the pressure side, around the leading edge of the blade 10, and to the suction side. The leading edge sheath may provide improved impact resistance to the blade 10 in the area most susceptible to impacts from e.g. ingested debris.

A core 22 is provided inside the fibre shell 12 and between the first and second beams 14,16.

In known blade structures, the beams 14, 16 are usually made of a carbon composite material. The space between the beams is filled with a filler such as foam or a honeycomb structure material, to form the blade core and the structure is encased in the shell 12.

As mentioned above, however, thermoset resins or epoxy have a relatively long cure cycle and have a fairly low impact strength which may, to satisfy the needs of an aircraft, lead to oversizing the beams. This results in increased weight and cost. Furthermore, the setting process in not reversible and so in case of damage or wear of parts of the blade, the entire blade needs to be replaced.

In recent years, there is an ongoing move, particularly in the aerospace industry, from thermoset resins to thermoplastic resins. Thermoplastic resins have a shorter processing cycle and so manufacturing processes are faster. Thermoplastics also exhibit greater impact strength than thermoset resins. In addition, parts made of thermoplastic materials can be repaired in that the material can be melted and other components can be repaired or replaced.

On the other hand, such thermoplastic materials have very high processing temperatures in the region of 400 deg. C. and known core materials and other materials used in conventional blades are often not compatible with such temperatures. A further challenge occurs if metal parts are used in combination with the thermoplastic material, since thermal stresses may not be manageable. In addition, the tempering temperature of the metal material maybe too low for some potential materials, leading to degradation of their mechanical properties.

The present disclosure makes use of thermoplastic FRC materials to make the spars or beams that form the main structural elements of the blade. These will provide a high strength to weight ratio and high impact strength. Further, the beams can, potentially, be repaired and used to make a new blade.

The strength of the blade is maximized by use of a core material between and around the beams through which a thermoset resin is injected and sets around the beams and also around fibers of the fiber shell forming the exterior of the blade. Resin Transfer Molding (RTM) of the thermoset resin can also provide adhesion of the shell to the beams to improve the structure. In some examples, the surface of the beam may be treated or surface-activated e.g. by sanding, plasma treatment, laser treatment etc. to promote adhesion.

Metal components such as a weight and/or a blade root for attaching the blade to a hub, can also be incorporated into the blade structure.

In one example, the structure of the blade may be similar to that shown in FIG. 1, but the beams are made of thermoplastic material. The filler may be made e.g. of polyurethane foam or other filler material. If desired, although this is optional, a weight may be incorporated into the blade structure and/or a metal blade root may be integrated into the structure.

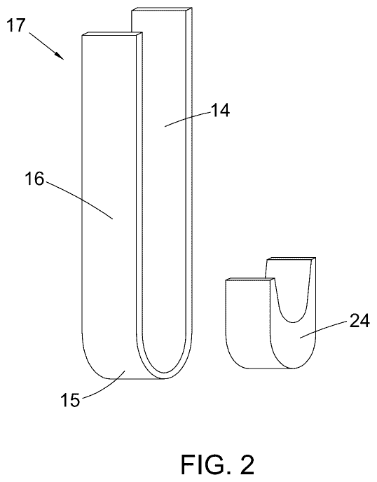

In another example, the beam structure may be formed as shown in FIG. 2, in a U-shape, thus forming effectively two beams produced as a single component.

In an alternative embodiment (not shown), there may be only a single solid beam (e.g. first beam).

The resulting blade structure in any example may be solid (containing the beams and filler material) or may, instead, be hollow by removing the filler (e.g. chemically or mechanically) after the RTM process.

The beam(s) may be made from a unidirectional fibre thermoplastic composite material or a mixture of fibres at different angles. The fibres of said composite may be carbon fibres. However, other fibres having sufficiently high strength and/or Young's modulus may be used, including aramid fibres or glass fibres. The fibres extend along an axis from a root of the blade 10 to a tip of the blade 10. The fibres of the beam 14, 16 may thereby provide good longitudinal and bending stiffness and strength to the overall blade 10.

As shown in FIG. 2, the first and second beams 14,16 may be formed as a single U-shaped piece 17 of FRC thermoplastic material. The two “legs” of the U-shape respectively form the first 14 and second beams 16 and these legs join together at a curved base portion 15 in order to provide an attachment loop providing a strong structural member to react to G-forces.

A root insert 24 may be placed between the two beams 14,16, at the curved base portion 15. The root insert 24 may be made from a FRC thermoplastic material. The root insert material may have either short or long/continuous fibres. As used in the art of FRC materials, “short fibres” typically refers to fibres less than 1 mm long. Correspondingly, “long fibres” are longer than 1 mm and may even be continuous throughout the entire length of a given FRC component. The root insert may be made by other processes e.g. injection molding, forged carbon machining, laid-up fibers etc.

During manufacture, the U-shaped piece 17 may be pre-formed and then assembled together with the root insert 24. The two parts 17,24 may then be welded together, e.g. by local or global heating of the two parts. If both parts 17,24 use a thermoplastic as the matrix, the two (solid) parts 17 24 may be placed together and their thermoplastics can then be (partially) remelted in the welding process so as to weld the parts 17,24 together.

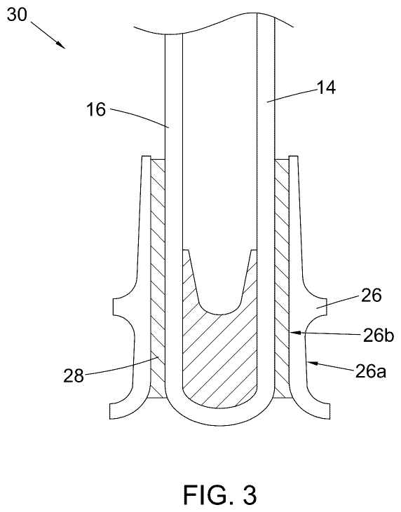

As shown in FIG. 3, the U-shaped piece 17 and the root insert 24 may then be inserted into a sleeve 26. The sleeve 26 may be metal and may be made of steel. The sleeve 26 may have one or more hardened ball races 26a for abutting against ball bearings in a bearing (not shown). Such a bearing may be used to allow the blade 10 to rotate to change pitch. Other types and arrangements of bearings may also be used, or designs without bearings are also contemplated.

The sleeve may be shaped such that its inner diameter fits the outer shape and diameter of the beam. There may be a gap between the inner diameter of the sleeve 26 and the outer surface of the U-shaped piece 17. This gap may be filled with dry plies of fibres 28. These dry plies may be formed as a sock that is slid over the U-shaped piece 17 and the U-shaped piece and sock are inserted together into the sleeve 26.

A shell 12 of dry fibers, e.g. carbon fibers, Aramid, glass or other fibers, which may be braided to form the shell 12 is provided around the one or more beams.

The shell 12 is filled with a filler material around the one or more beams. The filler material forms a core 22 of the blade inside the outer shell 12. The filler material may be a foam material, e.g. a polyurethane foam.

Resin Transfer Molding (RTM) is employed as a final or nearly-final step of the manufacturing process, such that the dry plies of fibres 28 of the sleeve (where present) or and the fibre shell 12, become impregnated with a matrix material and the resin acts as an adhesive between the core 22 and shell 12 and, optionally, between the core and the beam(s). This provides a hard and robust shell capable of withstanding large impact and a strong core and structure to the blade. As such, neither of these parts is “dry” in the finished blade 10, even though they are “dry” when initially added as part of the blade during construction.

Optionally, the U-shaped part may have a quasi-cylindrical outer profile in the portion of the U-shaped piece that is enclosed by the sleeve 26. This may generally match with a cylindrical profile of the inner surface 26b of the sleeve 26. Outside said region, the beams 14,16 (as portions of the U-shaped piece 17) may have different cross-sectional shapes. For example, the beams 14,16 may, in this region, act to define a portion of the airfoil cross=sectional profile of the finished blade, e.g. as shown in FIG. 1.

Optionally, the sleeve 26 may have a conical inner surface 26b to provide a mechanical connection holding the U-shaped piece 17 and the dry plies 28 within the sleeve 26.

The finished blade 10 may therefore have the following construction:

The sleeve 26 is located towards a base end of the blade 10 and may act as the root of the blade 10 where it is connected to a hub (e.g. fan hub or propeller hum). The first and second beams 14,16 are connected to the sleeve 26 via the plies of fibres 28, once impregnated with a matrix. The first and second beams 14,16 extend away from the base end of the blade 10 towards a tip end of the blade 10. The core 22 connects to the first and second beams 14,16, and the fibre shell 12 generally encapsulates the core 22 and beams 14,16. This arrangement is subjected to RTM to incorporate a matrix material within the fibre shell 12 and among the plies 28 of dry fibres, with the RTM creating a strong holding force or adhesion between the shell and the beam(s). The leading edge sheath 20, if present, is then connected to the outer surface of the fibre shell 12.

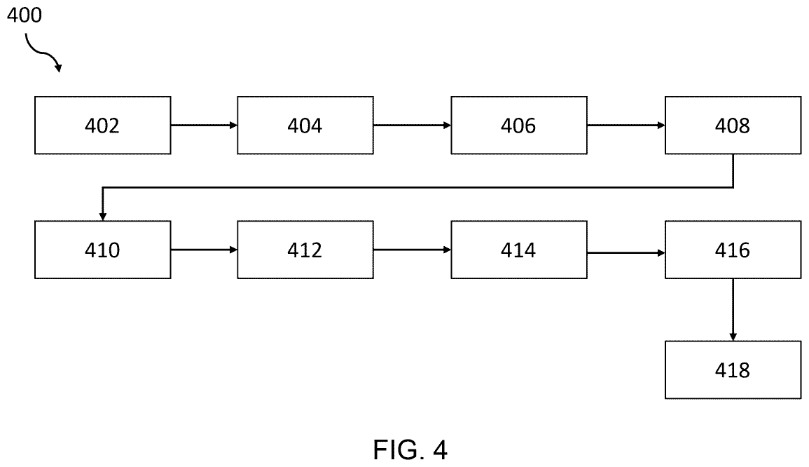

A method 400 of constructing the blade 10 will now be described with reference to FIG. 4.

At step 402, the one or more beams 14,16 are formed. In the example shown in FIG. 2, these two beams are formed as a single U-shaped piece 17, but the beams may have any known form and structure. The beam may be formed by preparing a layup of multiple layers of unidirectional dry carbon fibres in a mold, the mold having the shape of the finished piece/beam(s). This mold may therefore be termed a beam mold, to differentiate it from other mold(s) used in this method. Each layer may be unidirectional (i.e all the fibres of that layer are axially aligned with one another), but the fibres of on layer within the layup may be angled relative to the (unidirectional) fibres of another layer in the layup. A liquid thermoplastic is then injected into the beam mold such that it flows among the fibres. The liquid thermoplastic is then solidified, such that the finished beams/U-shaped piece is formed of a fibre reinforced thermoplastic material. In embodiments, the finished blade 10 has only a single beam . . . .

At step 404, the root insert 24 may be formed. This may be done by preparing a mold, and a liquid thermoplastic mixed with fibers is injected into the mold. This may be termed an insert mold. The thermoplastic may then be cooled to produce the (solid) root insert 24. Other ways of manufacturing a root insert 24, where required, are also possible.

At step 406, the root insert 24 is placed into the curved base portion 15 of the U-shaped piece 17 and these pieces are heated (either locally or globally) to weld the root insert 24 to the U-shaped piece 17.

Steps 402 and 404 may be performed in reverse order or in parallel. That is, the root insert 24 may be formed before or at the same time as the U-shaped piece 17 is formed. Alternatively, steps 402 and 404 may be replaced with a single step in which the fibres for the U-shaped piece 17 and fibres for the root insert are both placed into a mold (called a beam-and-insert mold) and then a thermoplastic resin is injected into, or provided as a powder on the beam-and-insert mold to form the root insert 24 and U-shaped piece 17 as a single unit.

At step 408, the dry plies of fibres 28 are placed around a portion of the one or more beams. In the example shown in FIG. 2, the dry plies of fibres are placed around the U-shaped piece 17, near the curved base portion 15.

At step 410, the one or more beams (e.g. U-shaped piece 17), root insert 24, and dry plies of fibres 28 are inserted into the sleeve 26, such that the dry plies of fibres abut the inner surface 26b of the sleeve 26. Alternatively, an epoxy adhesive may be applied on the inner surface 26b of the sleeve 26 before the other parts are inserted thereinto. The adhesive may then help with final strength of the bonding between the sleeve and the beam(s).

The unit comprising the U-shaped piece 17, root insert 24, dry plies of fibres 28 and the sleeve 26, and epoxy adhesive (if any) may generally referred to as piece 30.

At step 412, the piece 30 is combined with the core 22. This may be done in one of two ways.

The first method is to place the piece 30 into mold. The mold has substantially the shape of the finished blade 10. The inner shape of this mold is slightly smaller than the finished blade 10 (in view of the later addition of the fibre shell and subsequent molding, as discussed below). A core material is then injected in liquid form into the blade mold and then solidified to form the core 22. For example, the core 22 may be made from a polyurethane foam material. The piece 30 and core 22 may be considered an assembly that has substantially the shape of the finished blade 10.

In the second, alternative, method, the core 22 is preformed as an already-solid piece that is shaped (or machined into shape) to fit with the beams 14,16, such that the resulting assembly has substantially the shape of the finished blade 10.

At step 414, the fibre shell 12 is formed around the assembly. This may be done in a number of ways. In one example, the fibre shell 12 is pre-formed as a sock that is then pulled over the assembly. In another example, the assembly forms a mandrel and the fibres of the fibre shell 12 are braided or wrapped around the mandrel/assembly to form the fibre shell 12.

Steps 402,404 may be performed in parallel with forming a preformed core 22, and with preformed fibre shell 12 (e.g. as a sock). Being able to perform a number of the steps in parallel may speed up the overall manufacturing process.

At step 416, a Resin Transfer Molding (RTM) process is used. The assembly and fibre shell 12 are placed into a mold (called a blade mold) and thermoset resin is injected into the blade mold. The resin flows into the dry plies of fibres 28 and, once set, securely bonds the U-shaped piece 17 to the sleeve 26. The resin also flows among the fibres of the fibre shell 12, such that the fibre shell 12 of the finished blade 10 is a FRC thermoset material.

During RTM, the resin flows into any available gaps and spaces. For example, the resin may flow into gaps between the beams 14,16 and the core 22. The thermoset resin thereby helps to bind together the components of the blade 10, particularly the shell and the beam(s).

At optional step 418, the leading edge sheath 20 is applied over the fibre shell, at the leading edge of the blade 10. In this alternative, the finished blade 10 further comprises the leading edge sheath 20.

As discussed above, having the one or more beams made of thermoplastic material has many advantages including that the beam(s) can, in contrast to known blade designs, be repaired. Such materials also have high impact strength which is advantageous in flying vehicle blades which may e.g. experience bird strikes or the like. Having the beam(s) made of this strong thermoplastic material and manufactured as isolated part(s), means that the core, shell and metal sleeve can be made of other materials that do not necessarily withstand such high processing temperatures. The beam(s) can be formed first and then located in e.g. a mold and assembled with the core and the shell, forming an assembly that is then finished using RTM, as described above.

1. A rotary blade comprising:
one or more structural beams extending generally in a direction from a root end of the blade to a tip of the blade;
a shell enclosing the one or more structural beams and defining the outer shape of the blade,
wherein the one or more structural beams is made of a thermoplastic material and the shell comprises a fibrous material;
the blade further comprising:
a thermoset resin injected into the shell fibrous material to strengthen the shell and also to bond the shell to the one or more beams.

2. The blade of claim 1, wherein the one or more beams comprise a fiber reinforced composite including a thermoplastic material and reinforcing fibers.

3. The blade of claim 2, wherein the fibers include unidirectional carbon fibers.

4. The blade of claim 1, wherein the shell fibrous material comprises dry fibers.

5. The blade of claim 1, further comprising:
a filler material within the shell and forming a core encasing the one or more structural beams.

6. The blade of claim 5, wherein the filler material is a foam material, and optionally wherein the foam material is a polyurethane material.

7. The blade of claim 1, wherein the one or more beams comprise a U-shaped beam.

8. The blade of claim 1, further comprising:
a root insert at the root end of the blade.

9. The blade of claim 8, further comprising:
a sleeve around the root insert.

10. The blade of claim 1, in combination with a flying vehicle.

11. A method of forming a rotary blade, the method comprising:
forming one or more structural beams of the blade made of a thermoplastic material;
combining the one or more beams, with a core of filler material to produce an assembly;
applying a fibre shell over the assembly; and
performing Resin Transfer Molding (RTM), on the assembly in the fiber shell, wherein the RTM includes injecting a thermoset resin into the shell and the assembly and solidifying the resin, to strengthen the shell and also to create a bonding between the shell and the one or more beams, to produce the finished aircraft blade.

12. The method of claim 11, further comprising performing a surface treatment on the one or more beams to increase adhesion with the resin.

13. The method according to claim 11, wherein the one or more beams are two beams that are joined together at a curved base portion.

14. The method of claim 11, further comprising:
a retention sleeve at a root end of the blade.

15. The method according to claim 11, wherein the step of combining comprises:
placing the one or more beams, into a mold, the mold having substantially the shape of the finished aircraft blade;
injecting a liquid filler material into the mold; and
solidifying the filler material to form the core.
